(19) United States
(12) Patent Application Publication
(10) Pub. No.: US 2018/0319696 A1
(43) Pub. Date: Nov. 8, 2018

(54) FOLDABLE GLASS SHEET

(71) Applicant: ASAHI GLASS COMPANY, LIMITED, Chiyoda-ku (JP)

(72) Inventor: Shusaku AKIBA, Tokyo (JP)

(73) Assignee: ASAHI GLASS COMPANY, LIMITED, Chiyoda-ku (JP)

(21) Appl. No.: 15/966,218

(22) Filed: Apr. 30, 2018

(30) Foreign Application Priority Data
May 8, 2017 (JP) 2017-092675

(51) Int. Cl. C03B 23/00; C03C 3/093

(52) U.S. Cl. CPC C03B 23/0066; C03C 21/002; C03C 3/093

(57) ABSTRACT

The present invention relates to a foldable glass sheet having a thickness t of equal to or smaller than 0.2 mm and having a surface compressive stress CS of greater than 700 MPa, in which when the glass sheet is subjected to a bending test in which, while bending and supporting the glass sheet by a first support board and a second support board which are parallel to each other, the second support board is moved relative to the first support board by equal to or greater than 200 mm in a state of maintaining an interval between a support surface of the first support board and a support surface of the second support board, the glass sheet is not broken even in a case where a curvature radius of a bent portion of the glass sheet is set to equal to or smaller than 10 mm.

### TECHNICAL FIELD

The present invention relates to a glass sheet which is foldable in a curved surface shape.

### BACKGROUND ART

In recent years, a glass sheet having high texture, high strength and excellent heat resistance has been increasingly used as a cover glass of a display device for protecting the display device. Particularly, in a display of a mobile phone, a personal digital assistant (PDA) or the like, a high-strength cover glass is required, and thus a chemically strengthened glass sheet is used as such a cover glass.

For example, as described in PTL 1, a chemically strengthened glass sheet is obtained by immersing a glass sheet in a molten salt containing an alkali metal, and substituting an alkali metal (ion) having a small atomic diameter existing on the surface of the glass sheet with the alkali metal (ion) having a large atomic diameter existing in the molten salt.

Meanwhile, various designs are required for mobile terminals and, for example, there is a demand for a foldable terminal or a windable terminal. However, the conventional chemically strengthened glass as described above cannot satisfy such a demand, and there is a problem where breakage starts from minute scratches existing on a surface in case of folding or winding.

### PRIOR ART DOCUMENT

### Patent Literature

[PTL 1] JP-A-2016-000670

### SUMMARY OF THE INVENTION

### Problems that the Invention is to Solve

In order for a glass sheet to be foldable, small thickness and high strength are required. However, conventionally, it has been difficult to attain sufficient strength for a very thin glass sheet even with chemical strengthening.

An object of the present invention is to provide a glass sheet which is foldable in a curved surface shape without breaking even if scratches or the like exist on the surface, and has sufficient strength as a cover glass.

### Means for Solving the Problems

In order to attain the above object, the present invention relates to a foldable glass sheet, having a thickness t of equal to or smaller than 0.2 mm and a surface compressive stress CS of greater than 700 MPa, in which when the glass sheet is subjected to a bending test in which, while bending and supporting the glass sheet by a first support board and a second support board which are parallel to each other, the second support board is moved relative to the first support board by equal to or greater than 200 mm in a state of maintaining an interval between a support surface of the first support board and a support surface of the second support board, the glass sheet is not broken even in a case where a curvature radius of a bent portion of the glass sheet is set to equal to or smaller than 10 mm.

According to the glass sheet of the present invention, the thickness thereof is equal to or smaller than 0.2 mm, and thus it is possible to easily bend the glass sheet.

In addition, according to the glass sheet of the present invention, as the thickness thereof is equal to or smaller than 0.2 mm, and the surface compressive stress (hereinafter, referred to as “CS” in some cases) is greater than 700 MPa, even if minute scratches exist on the surface, breakage does not occur from the scratches in the bending test as described-above, that is, a bending test in which while bending and supporting the glass sheet by a first support board and a second support board which are parallel to each other, the second support board is moved relative to the first support board by equal to or greater than 200 mm in a state of maintaining an interval between a support surface of the first support board and a support surface of the second support board. Further, as the glass sheet is not broken in a case where the glass sheet is held in a state in which the curvature radius is equal to or smaller than 10 mm, the glass sheet can be folded substantially in a curved surface shape.

### Advantageous Effect of the Invention

As described above, according to the present invention, it is possible to provide a glass sheet which is foldable in a curved surface shape without breaking even if scratches or the like exist on the surface. Accordingly, it can be applied to various designs of various kinds of mobile terminals, and it can be used as a cover glass or the like of a terminal where the display surface thereof is foldable.

### BRIEF DESCRIPTION OF DRAWINGS

FIG. 1 illustrates an example of a state where a glass sheet is folded.

FIG. 2 is a diagram showing a relationship of a thickness of a glass sheet and a surface compressive stress.

FIG. 3 is a diagram illustrating a state where a test piece is set to a bending test apparatus.

FIG. 4 is a diagram illustrating a state during a test with the bending test apparatus.

### MODE FOR CARRYING OUT THE INVENTION

Hereinafter, the present invention will be described in detail. The present invention is not limited to the following embodiments, and can be optionally modified and implemented without departing from the gist of the present invention.

### (Properties of Glass Sheet)

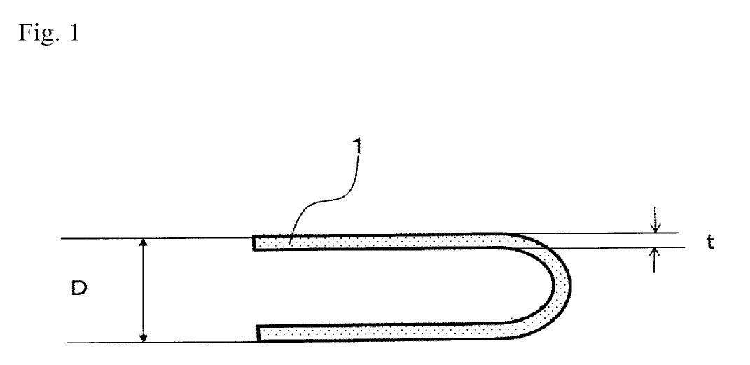

A glass sheet of the present invention has a thickness of equal to or smaller than 0.2 mm. Since the thickness is equal to or smaller than 0.2 mm, it is light and foldable. That is, even at a temperature lower than a glass transition point, the glass sheet can be deformed from a flat sheet shape to a folded state as illustrated in FIG. 1. Therefore, it is easy to return from the folded state to the flat sheet shape, and it can be used as a cover glass or the like of a terminal where the display surface thereof is foldable.

For ease of folding, the thickness of the glass sheet is preferably equal to or smaller than 0.1 mm, is more preferably equal to or smaller than 0.07 mm, and is still more preferably equal to or smaller than 0.05 mm. In addition, for ease of handling, the thickness is preferably equal to or greater than 0.03 mm, and is more preferably equal to or greater than 0.05 mm.

The glass sheet of the present invention is a glass sheet (chemically strengthened glass sheet) including a compression stress layer on the surface. In addition, the glass sheet of the present invention has the CS of greater than 700 MPa, and thus is less likely to be broken even minute scratches on the surface are extended at the time of folding. Therefore, also because of the thickness being 0.2 mm or less, breakage does not occur for a curvature radius of a bent portion of equal to or smaller than 10 mm, in a case where a bending test is performed by a method in which while bending and supporting the glass sheet by a first support board and a second support board which are parallel to each other, the second support board is moved relative to the first support board by equal to or greater than 200 mm in a state of maintaining an interval between a support surface of the first support board and a support surface of the second support board. As a result, for example, in a rectangular shape with a short side of 100 mm and a long side of 200 mm, the long side can be folded so as to make opposing short sides contact each other and the radius of curvature of the bent portion can be made equal to or smaller than 10 mm without breakage of the glass sheet. Thereby the glass sheet can be substantially folded.

The CS is preferably equal to or greater than 850 MPa, is more preferably equal to or greater than 900 MPa, is still more preferably equal to or greater than 950 MPa, is particularly preferably greater than 1000 MPa, and is most preferably equal to or greater than 1100 MPa. On the other hand, since the tensile stress value (CT; Center Tension) of the center of the glass may become excessively large and the glass may crush violently when being broken, the CS is preferably equal to or lower than 1700 MPa, is more preferably equal to or lower than 1400 MPa, is still more preferably equal to or lower than 1300 MPa, and is particularly preferably equal to or lower than 1280 MPa.

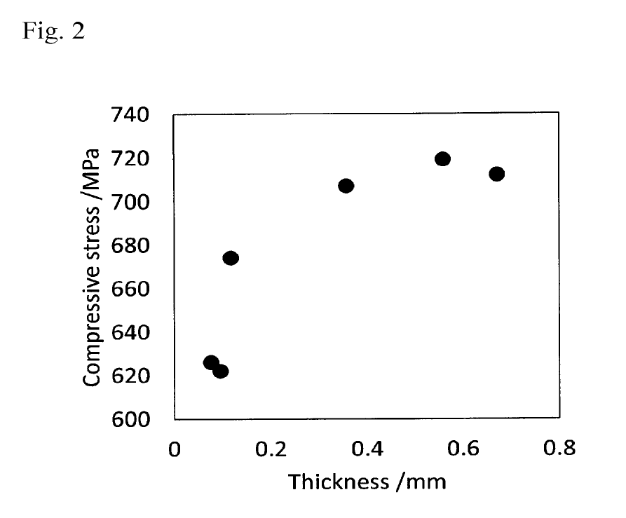

FIG. 2 is a diagram regarding glass sheets which have a composition of, by mol % based on oxide, 68.8% of SiO₂, 3.0% of Al₂O₃, 6.2% of MgO, 7.8% of CaO, and 14.2% of Na₂O, and have different thicknesses, and in which the surface compressive stress CS of the glass sheets subjected to an ion exchange treatment for 24 hours with molten potassium nitrate at 400° C. is plotted against the thickness of the glass sheet. As apparent from FIG. 2, in a case where chemical strengthening is performed on the glass sheet having the same composition under the same treatment condition, the CS is likely to be decreased as the thickness of the glass sheet is smaller and, in particular, in a case where the thickness of the glass sheet is equal to or smaller than 0.2 mm, it is difficult to obtain high strength. The reason is considered that in a case where the thickness of the glass sheet is small, the surface layer having a large volume formed by ion exchange is required to be held by the inner glass layer having a small volume, and thus when the rigidity of the inner glass layer is insufficient, stress relaxation occurs without completely supporting the surface layer.

However, by adjusting the glass composition, the CS can be increased even if the thickness of the glass sheet is small. A preferable glass composition will be described below.

FIG. 1 illustrates an example of a folded state. In FIG. 1, t represents a thickness of a glass sheet. D represents a width in the folded state, and one half thereof is a curvature radius.

In addition, for example, the glass sheet with an area of equal to or larger than 100 cm² is preferably not to be broken even when the curvature radius of the bent portion is set to be equal to or less than 10 mm. In this case, the curvature radius preferably can be set to be equal to or less than 5 mm, is more preferably equal to or less than 3 mm, and is still more preferably equal to or less than 2 mm, and is particularly preferably equal to or less than 1 mm.

Conventionally, in order to evaluate the bending strength of a thin sheet, a method of, while supporting a bent test piece by two support boards arranged in parallel, narrowing the interval between the two support boards and measuring the interval and the stress at the time of reaching the breakage has been used. However, in such a method, the stress is applied only to the most bent portion of the test piece, so that it is not possible to evaluate whether or not the test piece is windable.

In addition, in order to correctly evaluate the strength of the glass sheet, the stress should be added on the surface of the glass sheet as widely as possible, so as to test for the presence or absence of breakage. It is because, in general, it is said that invisible innumerable fine scratches (latent damage) exist on the surface of the glass sheet, and the glass sheet is broken due to the concentration of stress at the tip end thereof.

In addition, it is preferable that the glass sheet is not broken in a case where the glass sheet is held in a state for 60 minutes, in which the curvature radius of the bent portion of the glass sheet is equal to or smaller than 10 mm.

In addition, in a case where scratches are generated on the surface of the glass sheet, and the depth of the scratch is greater than a depth of compressive stress layer (DOL) so as to reach the tensile stress layer, the glass sheet is likely to be broken. Thus the DOL is preferably equal to or greater than 10 μm, is more preferably equal to or greater than 15 μm, is still more preferably equal to or greater than 20 μm, is particularly preferably equal to or greater than 25 μm, and is most preferably equal to or greater than 30 μm. On the other hand, from the aspect that the tensile stress value (CT) of the glass sheet is excessively large, and thereby the glass sheet may be crushed when being broken, the DOL is preferably equal to or less than 60 μm, and is more preferably equal to or less than 50 μm.

The CT is preferably equal to or lower than 4×(t+0.02)⁻²+90.

Here, the values of CS and DOL can be measured with a surface stress meter.

In order to increase the bending strength of the glass, it is important that the surface compressive stress CS is large, but it is preferable that the depth of compressive stress layer DOL is also large. However, when both CS and DOL are increased, a large CT occurs, and thus the safety at the time of breakage becomes a problem. On the other hand, in order to maintain the strength of the glass sheet, the thickness t is preferably large. However, if t is large, the glass sheet is difficult to bend. To sum up, the value of (CS×DOL/t) is preferably within a certain range.

Specifically, in order to enhance the bending strength of glass, a value (CS×DOL/t) obtained by dividing a product of the surface compressive stress CS (unit: MPa) and the depth of compressive stress layer DOL (unit: μm) by the thickness t (unit: μm) is preferably equal to or greater than 116, is more preferably equal to or greater than 130, is still more preferably equal to or greater than 150, and is particularly preferably equal to or greater than 170. In terms of safety at the time of breakage, (CS×DOL/t) is preferably equal to or lower than 450, is more preferably equal to or lower than 410, is still more preferably equal to or lower than 390, is particularly preferably equal to or lower than 370, and is most preferably equal to or lower than 350. At this time, the surface compressive stress CS is preferably greater than 900 MPa.

In order that the applied stress sufficiently exhibits a function, the latent damage existing on the surface of the glass is preferably small, and the curvature radius of the tip end thereof is preferably large.

That is, in order to maintain the strength of the glass sheet after chemical strengthening, the depth of the latent damage existing on the surface of the glass sheet is preferably equal to or less than 5 μm, is more preferably equal to or less than 4 μm, is still more preferably equal to or less than 3 μm, is particularly preferably equal to or less than 2 μm, and is most preferably equal to or less than 1 μm. From the same reason, the curvature radius at the tip end of the latent damage of the surface is preferably equal to or greater than 0.1 μm, is more preferably equal to or greater than 0.5 μm, and is still more preferably equal to or greater than 1 μm.

Here, “latent damage depth” can be measured by the following method. First, after etching the glass sheet, the surface of the glass sheet is polished, washed, and dried, and a processed altered layer having a circular pit or an elliptical pit treated by the etching treatment is observed with an optical microscope. Here, “processed altered layer” means a layer on which scratches, cracks, and the like exist, which are generated on the glass sheet in processing steps such as shaping, chamfering, and grinding. For example, an objective lens of an optical microscope having a magnification of 20 times is used and observation is performed with an observation field of view of 635 μm×480 μm. The observation of latent damages due to such polishing and etching are repeated, and the amount of polishing of the glass sheet until no circular pit or elliptical pit is observed is set as “latent damage depth”.

Here, “etching” is performed by immersing the entire of chemically strengthened glass sheet into an etchant at room temperature (25° C.). An aqueous solution containing 5% by mass of hydrofluoric acid (HF) and 95% by mass of pure water is used as the etchant. The etchant penetrates into the latent damage formed on the surface or inside of the chemically strengthened glass sheet so as to expand the latent damages. Etching is performed so as to clarify the latent damage.

“Etching amount” is controlled by immersion time. Specifically, after calculating an etching rate by performing the etching for a predetermined time by using glass of the same composition in advance, etching is performed by adjusting the immersion time so as to obtain a desired etching amount. Note that, hydrofluoric acid concentration may be changed in order to adjust the etching rate.

In addition, “curvature radius at tip end of the latent damage” can be measured by using a laser microscope or an atomic force microscope (AFM).

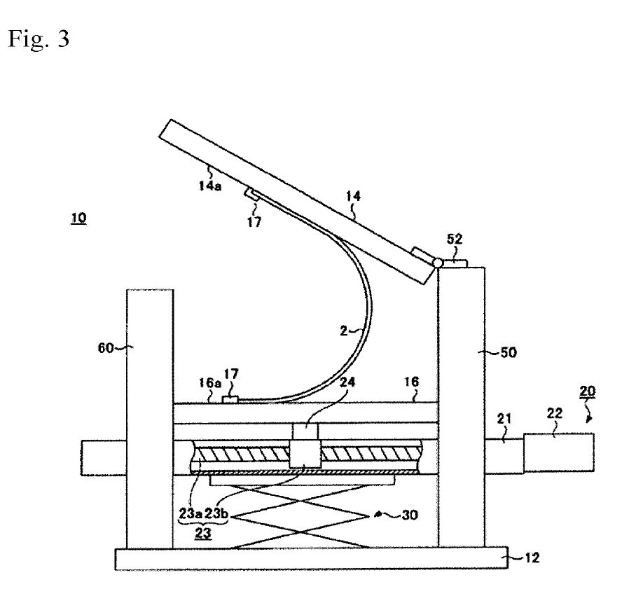

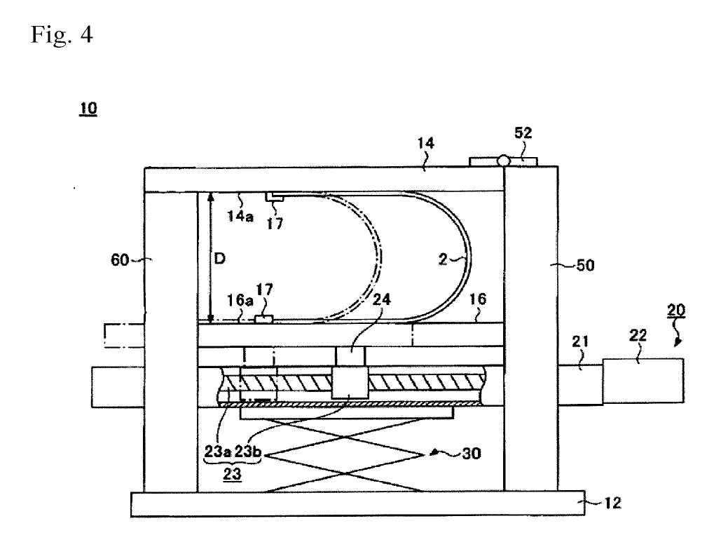

Next, an example of the bending test apparatus will be described. FIG. 3 illustrates the arrangement when setting a test piece 2 (glass sheet) to be subjected to the bending test. FIG. 4 is a diagram during the test, and in a state indicated by a solid line, when a lower side support board 16 is horizontally moved with respect to a base 12 in the left direction in the drawing, a state indicated by a dashed-dotted line is obtained. According to such an apparatus, when the lower side support board 16 is moved by equal to or greater than 200 mm, the bending test can be performed by a method in which while bending and supporting the glass sheet by the first support board and the second support board which are parallel to each other, the second support board is moved relative to the first support board by equal to or greater than 200 mm in a state of maintaining an interval between a support surface of the first support board and a support surface of the second support board. According to this method, since a bending stress can be applied to a large area of the test piece 2, the winding property can be evaluated.

The bending test apparatus 10 is provided with the base 12, an upper side support board 14, the lower side support board 16, a moving unit 20, an adjusting unit 30, a supporting unit 50, and a placement portion 60. The upper side support board 14 and the lower side support board 16 support the test piece 2.

The moving unit 20 moves the position of the lower side support board 16 relative to the upper side support board 14 in a state of maintaining an interval D between the support surface 14a of the upper side support board 14 and the support surface 16a of the lower side support board 16 which are parallel to each other.

The moving unit 20 is configured to include a lifting frame 21, a motor 22, a ball screw mechanism 23 (23a and 23b), and a slider block 24. The slider block 24 is connected to the lower side support board 16, and is moved from side to side relative to the base 12 together with the lower side support board 16.

The adjusting unit 30 adjusts the interval D between the support surface 14a of the upper side support board 14 and the support surface 16a of the lower side support board 16 which are parallel to each other. To adjust the interval D, the adjusting unit 30 lifts or lowers the lower side support board 16 relative to the base 12.

The supporting unit 50 is fixed to the base 12, and supports the upper side support board 14 in a rotatable manner via a hinge (connecting portion) 52. Specifically, the upper side support board 14 is rotatably disposed between a test position (the position illustrated in FIG. 4) where the support surface 14a of the upper side support board 14 is parallel with the support surface 16a of the lower side support board 16, and a set position (the position illustrated in FIG. 3) where the support surface 14a of the upper side support board 14 is oblique to the support surface 16a of the lower side support board 16. During the upper side support board 14 is rotated to the set position from the test position, the curvature radius of the bent portion of test piece 2 supported by the upper side support board 14 and the lower side support board 16 is gradually increased. Note that, the supporting unit 50 also functions as a guide for vertically guiding the lifting frame 21.

The placement portion 60 is fixed to the base 12, and the upper side support board 14 disposed on the upper side of the lower side support board 16 is placed on the placement portion 60. The upper side support board 14 is placed on the upper end surface of the placement portion 60 when being in the test position (the position in FIG. 4).

In a case where the bending test is performed by using the apparatus, an operator firstly fixes the test piece 2 to the upper side support board 14 and the lower side support board 16 by using an adhesive tape 17 or the like in the set position (the position illustrated in FIG. 3). The curvature radius of the bent portion of the test piece 2 at the time of setting is sufficiently larger than the curvature radius at the time of the test (the position illustrated in FIG. 4). At the time of setting, a tensile stress generated in the bent portion of the test piece 2 is sufficiently small, and thus cracks hardly occurs in the bent portion.

Next, the operator manually operates the adjusting unit 30 to adjust the interval D between the support surface 14a of the upper side support board 14 and the support surface 16a of the lower side support board 16 which are parallel to each other, and thereby it is possible to cause the tensile stress of a set value to the test piece 2 bent between the upper side support board 14 and the lower side support board 16.

A tensile stress T occurs at a peak (a right end of the test piece 2 in FIG. 4) of the bent portion of the test piece 2 can be calculated based on the following Expression (1).

T=A×E×t/(D−t) (1)

In Expression (1), A represents a constant (1.198) specific to this test, E represents Young's modulus of the test piece 2, and t represents the thickness of the test piece 2. As apparent from Expression (1), as the interval D (D>2×t) is narrow, the tensile stress T becomes large.

In the glass sheet of the present invention, a temperature T2 at which the viscosity of glass is 10² dPa·s, that is an estimated temperature for melting the glass, is preferably equal to or lower than 1660° C., is more preferably equal to or lower than 1650° C., and is still more preferably equal to or lower than 1645° C. When the temperature T2 is higher than 1660° C., solubility of glass is deteriorated.

In the glass sheet of the present invention, a temperature T4 at which the viscosity of glass is 10⁴ dPa·s, that is an estimated temperature for forming glass, is preferably equal to or lower than 1255° C., is more preferably equal to or lower than 1240° C., is still more preferably equal to or lower than 1230° C., and is particularly preferably equal to or lower than 1225° C. When the temperature T4 is higher than 1255° C., formability of the glass sheet deteriorates.

Note that, the temperature T2 and the temperature T4 can be measured by using a rotary viscometer.

In the glass sheet of the present invention, as the DUV resistance, DUV induced absorption Δα at each wavelength represented by the following expression is preferably equal to or less than 0.095, is more preferably equal to or less than 0.085, and still more preferably equal to or less than 0.08. Where the transmittance in a wavelength region of 380 to 780 nm before UV irradiation on the short wavelength side is set as T0 and, the transmittance in a wavelength region of 380 to 780 nm after irradiation is set as T1.

Δα=−ln(T1/T0)

The DUV resistance in the present specification means that the reduction of the transmittance at the wavelength of 380 to 780 nm is suppressed in a case of performing irradiation with UV (DUV) with a wavelength of 100 to 280 nm, that is, in a case of performing irradiation with a low pressure mercury lamp with a main wave length of 185 nm and 254 nm, an Xe gas excimer lamp with main wavelength of 172 nm, an ArF excimer lamp with main wavelength of 193 nm, a KrF excimer lamp with a main wavelength of 248 nm, or the like.

The UV irradiation on the short wavelength side is generally used for a UV cleaning treatment and a surface modification of the substrate, a UV sterilization treatment, and the like.

The glass transition point (Tg) of the glass sheet of the present invention is preferably equal to or higher than 550° C., is more preferably equal to or higher than 580° C., is still more preferably equal to or higher than 600° C., is particularly preferably equal to or higher than 620° C., or is preferably equal to or lower than 700° C. When Tg is equal to or higher than 550° C., it is advantageous in terms of suppression of the stress relaxation during the chemical strengthening treatment, suppression of thermal warping, and the like.

The adjustment of Tg can be performed by, for example, adjusting the total amount of SiO₂ and Al₂O₃, and the amount of alkali metal oxide and alkaline earth oxide.

The average coefficient of thermal expansion a of the glass sheet of the present invention is, within a temperature range of 50° C. to 350° C., preferably in a range of 65×10⁻⁷ to 110×10⁻⁷/K, is more preferably equal to or higher than 70×10⁻⁷/K, is still more preferably equal to or higher than 80×10⁻⁷/K, is particularly preferably equal to or higher than 85×10⁻⁷/K, or preferably equal to or lower than 100×10⁻⁷/K, and is more preferably equal to or lower than 97×10⁻⁷/K. When the average coefficient of thermal expansion is 65×10⁻⁷/K or higher and 110×10⁻⁷/K or lower, it is advantageous in terms of matching of the thermal expansion coefficient with a metal or another substance. The adjustment of the average coefficient of thermal expansion can be performed by, for example, adjusting the amount of alkali metal oxide and alkaline earth oxide.

The specific gravity of the glass sheet of the present invention at room temperature is preferably in a range of 2.35 to 2.6 g/cm³, is more preferably equal to or greater than 2.38 g/cm³, is still more preferably equal to or greater than 2.40 g/cm³, and is more preferably equal to or less than 2.55 g/cm³, and is still more preferably equal to or less than 2.50 g/cm³. If the density is equal to or greater than 2.35 g/cm³, Vickers hardness of glass becomes high to make the glass surface difficult to be scratched. On the other hand, if the density is equal to or less than 2.6 g/cm³, the glass sheet is lightweight to make handling of the glass sheet easy. Further, it is possible to reduce deflection by the weight of the glass sheet itself.

Young's modulus E of the glass sheet of the present invention is preferably equal to or greater than 60 GPa. Crack resistance and breaking strength of the glass may be insufficient when it is less than 60 GPa. Also, it is difficult to obtain sufficient CS. It is more preferably equal to or greater than 68 GPa, and is still more preferably it is equal to or greater than 70 GPa.

Since the excessively high Young's modulus makes the stress generated when bending increase, it is preferably equal to or less than 120 GPa. It is more preferably equal to or less than 100 GPa, and is still more preferably equal to or less than 80 GPa.

Poisson's ratio σ of the glass sheet of the present invention is preferably equal to or lower than 0.28. When the ratio is greater than 0.28, crack resistance of the glass may be insufficient. It is more preferably equal to or lower than 0.25.

Note that, various properties of the above-mentioned glass sheet can be appropriately adjusted by adjusting treatment conditions of a chemical strengthening treatment described below, a composition of the glass sheet (matrix composition before chemical strengthening) and the like.

### (Composition of Glass Sheet)

Hereinafter, the glass composition of the glass for chemical strengthening may be referred to as the matrix composition of chemically strengthened glass. In a case where the thickness of the chemically strengthened glass is sufficiently large, the portion having the tensile stress of the chemically strengthened glass (hereinafter, also referred to as a tensile stress portion) is a portion not ion-exchanged, so that the tensile stress portion of the chemically strengthened glass has the same composition as that of the glass before chemical strengthening. In that case, the composition of the tensile stress portion of the chemically strengthened glass can be regarded as the matrix composition of the chemically strengthened glass.

A glass used for the glass sheet of the present invention is not limited as long as it can be chemically strengthened by ion exchange. Specifically, it may be aluminosilicate glass, soda lime glass, lithium glass, borosilicate glass, and the like. It is not particularly limited, but aluminosilicate glass is preferable.

Each component constituting the glass will be described below. In the present specification, when simply described as “%” for the glass composition, it means “mol % based on oxide”, and “to” means it is equal to or greater than the lower limit value and is equal to or less than the upper limit value.

SiO₂ is a main component constituting glass. In addition, SiO₂ is a component that reduces occurrence of cracks when the glass surface is scratched, or reduces destruction rate when indentations are applied after chemical strengthening. SiO₂ is also a component that increases the acid resistance of glass and reduces amount of sludge during etching treatment (hydrofluoric acid resistance). For this reason, the content of SiO₂ is equal to or greater than 50%, is preferably equal to or greater than 58%, and is more preferably equal to or greater than 60%, is still more preferably equal to or greater than 63%, is particularly preferably equal to or greater than 66%, and is most preferably equal to or greater than 68%.

On the other hand, if the content of SiO₂ is excessively large, the viscosity tends to be excessively high and productivity such as solubility and formability tends to be low. For this reason, the content of SiO₂ is equal to or less than 75%, is preferably equal to or less than 73%, is more preferably equal to or less than 72%, is still more preferably equal to or less than 71%, and is particularly preferably equal to or less than 70%.

The more Al₂O₃ is, the higher the CS can be in the chemical strengthening treatment, while the DOL is decreased. For this reason, the content of Al₂O₃ is equal to or greater than 8%, is preferably equal to or greater than 9%, is more preferably equal to or greater than 11%, is still more preferably equal to or greater than 12%, and is particularly preferably equal to or greater than 13%. On the other hand, when the content of Al₂O₃ is greater than 30%, the acid resistance is lowered and devitrification tends to occur. In addition, meltability is remarkably deteriorated. The content of Al₂O₃ is equal to or less than 30%, is preferably equal to or less than 25%, is more preferably equal to or less than 20%, is still more preferably equal to or less than 18%, and is particularly preferably equal to or less than 15%.

Both Li₂O and Na₂O are components that can form the surface compressive stress by the ion exchange, and at least one thereof is contained. The total content of Li₂O and Na₂O is preferably equal to or greater than 10%, is more preferably equal to or greater than 12%, is still more preferably equal to or greater than 14%, and is particularly preferably equal to or greater than 16%. On the other hand, Li₂O and Na₂O tend to decrease the acid resistance of the glass, and thus the total content thereof is preferably equal to or less than 30%, is more preferably equal to or less than 26%, is still more preferably equal to or less than 22%, and is particularly preferably 18%.

In a case where the chemical strengthening treatment for exchanging Li ions on the glass surface with Na ions, the content of Li₂O is preferably equal to or greater than 3%, is more preferably equal to or greater than 4%, is still more preferably equal to or greater than 5%, is particularly preferably equal to or greater than 6%, and is most preferably equal to or greater than 7%. On the other hand, when the content of Li₂O is greater than 20%, the acid resistance of glass is remarkably deteriorated, and thus it is necessary to be equal to or lower than 20%, is preferably equal to or less than 18%, is more preferably equal to or less than 16%, is still more preferably equal to or less than 15%, and is particularly preferably equal to or less than 13%.

On the other hand, in a case of performing the chemical strengthening treatment for exchanging Na ions on the glass surface with K ions, when the content of Li₂O is equal to or greater than 3%, the value of compressive stress is decreased. In this case, the content of Li₂O is preferably equal to or less than 3%, is more preferably equal to or less than 2%, is still more preferably equal to or less than 1%, is particularly preferably equal to or less than 0.5%, and it is most preferable that Li₂O is not substantially contained.

In the present specification, “not substantially contained” means that it is not contained as except for unavoidable impurities contained in raw materials and the like, that is, it is not intentionally contained.

When the chemical strengthening treatment of exchanging Li ions on the glass surface with Na ions is performed, Na₂O may not be contained, but may be contained in a case where meltability of the glass is thought important. The content of Na₂O in a case of being contained is preferably equal to or greater than 1%. The content of Na₂O is more preferably equal to or greater than 2%, and is still more preferably equal to or greater than 3%. On the other hand, when the content of Na₂O is greater than 8%, the surface compressive stress formed by the ion exchange is remarkably deteriorated. The content of Na₂O is preferably equal to or less than 8%, is more preferably equal to or less than 7%, is still more preferably equal to or less than 6%, is particularly preferably equal to or less than 5%, and is most preferably equal to or less than 4%.

On the other hand, it is indispensable in the case of performing the chemical strengthening treatment for exchanging Na ions on the glass surface with K ions, and the content is equal to or greater than 5%. The content of Na₂O is preferably equal to or greater than 7%, is more preferably equal to or greater than 10%, is particularly preferably equal to or greater than 11%, and is most preferably equal to or greater than 12%. On the other hand, when the content of Na₂O is greater than 20%, the acid resistance of the glass is remarkably deteriorated. The content of Na₂O is preferably equal to or less than 20%, is more preferably equal to or less than 18%, is still more preferably equal to or less than 16%, is particularly preferably equal to or less than 15%, and is most preferably equal to or less than 14%.

K₂O is not essential, but when it is contained, it has an effect of increasing the ion exchange rate to deepen DOL, and lowering the melting temperature of the glass, and is a component of increasing a non-bridging oxygen. It is also possible to avoid an increase in the change of the surface compressive stress due to a concentration of NaNO₃ in a potassium nitrate molten salt used during the chemical strengthening treatment. Furthermore, since a small amount of K₂O has an effect of suppressing an amount of tin invading from a bottom surface during forming by a float process, it is preferably contained when forming by the float process. In other to exhibit the above effects, the content of K₂O in the glass of the present invention is preferably equal to or greater than 0.5%, is more preferably equal to or greater than 1%, and is still more preferably equal to or greater than 2%. On the other hand, when the content of K₂O is excessively large, the CS is decreased, and thus the content of K₂O is equal to or less than 6%, is preferably equal to or less than 4%, and is more preferably equal to or less than 2%.

MgO is a component that can stabilize the glass, improve solubility, and suppress increase in the coefficient of thermal expansion (CTE) by decreasing the content of alkali metal by the addition of MgO. In order to exhibit the above effects, the content of MgO in the glass of the present invention is preferably equal to or greater than 3%, is more preferably equal to or greater than 4%, is still more preferably equal to or greater than 5%, is particularly preferably equal to or greater than 7%, and is most preferably equal to or greater than 8%. On the other hand, when the content of MgO is greater than 15%, devitrification tends to occur easily, which may cause defects. The content of MgO is equal to or less than 15%, is preferably equal to or less than 14%, is more preferably equal to or less than 12%, and is still more preferably equal to or less than 10%.

CaO and SrO are components for improving meltability and these components may be contained. The content of each of CaO and SrO in a case of being contained is preferably equal to or greater than 0.5%, is more preferably equal to or greater than 1%, is still more preferably equal to or greater than 2%, is particularly preferably equal to or greater than 3%, and is most preferably equal to or greater than 5%. On the other hand, when the total content is greater than 10%, the ion exchange performance is remarkably deteriorated. The content of each of CaO and SrO is preferably equal to or less than 10%, is more preferably equal to or less than 8%, is still more preferably equal to or less than 6%, is particularly preferably equal to or less than 4%, and is most preferably equal to or less than 2%.

BaO is a component for improving meltability and may be contained. The content of BaO in a case of being contained is preferably equal to or greater than 0.5%, is more preferably equal to or greater than 1%, is still more preferably equal to or greater than 2%, is particularly preferably equal to or greater than 3%, and is most preferably equal to or greater than 5%. On the other hand, when the content of BaO is greater than 10%, the ion exchange performance is remarkably deteriorated. The content of BaO is preferably equal to or less than 5%, is more preferably equal to or less than 3%, is still more preferably equal to or less than 1%, and it is most preferable that BaO is not contained in order to improve the ion exchange performance.

ZnO is a component for improving meltability of the glass and may be contained. The content of ZnO in a case of being contained is preferably equal to or greater than 0.5%. On the other hand, when the content of ZnO is greater than 10%, weathering resistance of the glass is remarkably deteriorated. The content of ZnO is preferably equal to or less than 10%, is more preferably equal to or less than 7%, is still more preferably equal to or less than 5%, 4%, 3%, is particularly preferably equal to or less than 2%, and is most preferably equal to or less than 1%.

The content (total content) of CaO+SrO+BaO is preferably equal to or greater than 0.5%, and is more preferably 1%. On the other hand, when the total content is greater than 10%, the ion exchange performance is remarkably deteriorated. The content (total content) of CaO+SrO+BaO is equal to or less than 10%, is preferably equal to or less than 5%, is more preferably equal to or less than 3%, is still more preferably equal to or less than 1%, and it is particularly preferable that those are not contained.

B₂O₃ is a component that improves chipping resistance and improves meltability of glass. B₂O₃ may not be contained, and the content of B₂O₃ in a case of being contained is preferably equal to or greater than 0.5%, is more preferably equal to or greater than 1%, and is still more preferably equal to or greater than 2%. On the other hand, when the content of B₂O₃ is greater than 5%, striae may occur due to volatilization upon melting, which may cause defects. The content of B₂O₃ is equal to or less than 10%, is preferably equal to or less than 5%, is more preferably equal to or less than 4%, and is still more preferably equal to or less than 3%.

ZrO₂ is a component for increasing the surface compressive stress by the ion exchange, and is a component for applying excellent DUV resistance, and thus may be contained. The content of ZrO₂ in a case of being contained is preferably equal to or greater than 0.5%, is more preferably equal to or greater than 1%. On the other hand, if the content of ZrO₂ is greater than 8%, devitrification tends to occur easily, which may cause defects. The content of ZrO₂ is preferably equal to or less than 8%, is more preferably equal to or less than 6%, is still more preferably equal to or less than 4%, is particularly preferably equal to or less than 2%, is most preferably equal to or less than 1.5%.

TiO₂ is a component for improving crushability of the glass and provides particularly excellent DUV resistance, and thus may be contained. The content of TiO₂ in a case of being contained is preferably equal to or greater than 0.1%, is more preferably equal to or greater than 0.15%, and is still more preferably equal to or greater than 0.2%. On the other hand, if the content of TiO₂ is greater than 5%, devitrification tends to occur easily, which may cause defects. The content of TiO₂ is preferably equal to or less than 5%, is more preferably equal to or less than 3%, is still more preferably equal to or less than 2%, is even still preferably equal to or less than 1%, is particularly preferably equal to or less than 0.5%, and is most preferably equal to or less than 0.25%.

The content (total content) of TiO₂ and ZrO₂ in a case of being contained is preferably equal to or greater than 0.1%, is more preferably equal to or greater than 0.5%, and is still more preferably equal to or greater than 1%. On the other hand, when the content of TiO₂+ZrO₂ is greater than 10%, devitrification tends to occur easily, which may cause defects. The content of TiO₂+ZrO₂ is equal to or less than 10%, is preferably equal to or less than 5%, is more preferably equal to or less than 3%, and is still more preferably equal to or less than 1%.

P₂O₅ has an effect of improving the ion exchange performance and chipping resistance, and thus may be contained. The content of P₂O₅ in a case of being contained is preferably equal to or greater than 0.5%, is more preferably equal to or greater than 1%, and is still more preferably equal to or greater than 2%. On the other hand, when the content of P₂O₅ is excessively large, crushability of the glass is remarkably deteriorated, and the acid resistance is remarkably deteriorated. Therefore, the content of P₂O₅ is preferably equal to or less than 6%, is more preferably equal to or less than 4%, is still more preferably equal to or less than 3%, and it is particularly preferable that P₂O₅ is not contained.

Y₂O₃, La₂O₃, and Nb₂O₅ are components for increasing hardness of glass and Young's modulus, and thus those components may be contained. The content of each of those components in a case of being contained is preferably equal to or greater than 0.5%, is more preferably equal to or greater than 1%, is still more preferably equal to or greater than 1.5%, is particularly preferably equal to or greater than 2%, and is most preferably equal to or greater than 2.5%. On the other hand, when the content of each of Y₂O₃, La₂O₃, Nb₂O₅ is greater than 8%, devitrification tends to occur easily, which may cause defects. The content of each of Y₂O₃, La₂O₃, and Nb₂O₅ is equal to or less than 8%, is preferably equal to or less than 6%, is more preferably equal to or less than 5%, is still more preferably equal to or less than 4%, is particularly preferably equal to or less than 3%, and it is most preferable that those are not contained.

Particularly, before the ion exchange, it is preferable to have a matrix composition (glass A) of, by mol % based on oxide, SiO₂: 50% to 75%, Al₂O₃: 8% to 30%, Na₂O+Li₂O: 10% to 30%, K₂O: 0% to 2%, MgO: 3% to 15%, B₂O₃: 0% to 5%, TiO₂+ZrO₂: 0% to 10%.

In addition, before the ion exchange, it is preferable to have a matrix composition (glass B) of, by mol % based on oxide, SiO₂: 50% to 75%, Al₂O₃: 9% to 20%, Na₂O: 10% to 20%, K₂O: 0% to 6%, MgO: 0% to 15%, CaO+SrO+BaO: 0% to 10%, TiO₂+ZrO₂: 0% to 5%, B₂O₃: 0% to 10%, Li₂O: 0% to 20%.

### (Manufacturing Method of Glass Sheet)

A manufacturing method of the glass sheet of the present invention is not particularly limited, and a method of forming the molten glass is also not particularly limited. For example, a glass raw material is appropriately prepared, heated to about 1500° C. to 1700° C., melted, homogenized by refining, stirring, or the like. Then, the molten glass is formed into a sheet shape by a well-known float process, a downdraw process (fusion processor the like), or a pressing process, or formed into a block shape by casting, and then followed by annealing. Then the glass is cut into a desired size to manufacture a glass sheet. If necessary, a polishing process is performed, but in place of or in addition to the polishing process, it is also possible to treat a surface of the glass sheet with a fluorinated agent. In consideration of stable production of a glass sheet, the float process or the downdraw process is preferable, and in consideration of production of a large-sized glass sheet, the float process is more preferable.

A thin glass sheet can be directly manufactured by the above glass forming method. Further, it is also possible to produce a thin glass sheet by thinning a glass sheet by a redraw process in which a glass sheet thicker than the target glass sheet is manufactured in advance, followed by heating again to near a softening point and elongating. It is also possible to manufacture a thin glass sheet by etching with a chemical solution using hydrofluoric acid or the like.

Next, the glass sheet is subjected to a chemical strengthening treatment. Before the chemical strengthening treatment, it is preferable to perform a shape machining according to the application, for example, mechanical process such as a cutting process, an end surface process, and a punching process.

In the cutting of the glass sheet, in order to maintain strength of the end surface after cutting, the depth of the scratches on the end surface formed during cutting is preferably equal to or less than 5 μm, is more preferably equal to or less than 4 μm, is still more preferably equal to or less than 3 μm, is particularly preferably equal to or less than 2 μm, and is most preferably equal to or less than 1 μm.

Examples of a cutting method include a method of physically scribing and breaking by using a wheel cutter or a diamond cutter, a method of optically dividing by using UV or a visible light laser, a method of thermally dividing by using an infrared laser or the like, a method of dividing by applying an electric field, and a method of dividing while etching with a chemical solution.

In addition, the end surface process (chamfering) may be a mechanical grinding process, and a treatment method with a chemical solution such as hydrofluoric acid, a fire polishing method or the like may be used. In the case of mechanical process, it is preferable to finish to a mirror polished state by using a brush or the like.

The chemical strengthening treatment is performed, for example, by cutting the manufactured glass into a desired size to prepare a glass sheet, then preheating the glass sheet to about 400° C., and performing, in a molten salt, ion exchange of Na on the surface of the glass sheet and K in the molten salt.

Further, after performing the ion exchange in the molten salt containing a specific salt, an acid treatment and an alkali treatment may be performed to make a glass sheet having higher strength.

Examples of the molten salt for performing the ion exchange treatment include alkali nitrates such as potassium nitrate, potassium sulfate and potassium chloride, alkali sulfates, and alkali chloride salts. These molten salts may be used independently or in combination of plural kinds. Also, in order to adjust the chemical strengthening properties, salts containing sodium may be mixed.

As a chemical strengthening method, an electric field application method may be used. The electric field application method is a method of applying a DC voltage when performing an ion exchange treatment for chemical strengthening. This method is preferable since ion exchange can be performed with a low treatment temperature.

Adjustment of the CS of glass sheet can be performed, in a case of performing the ion exchange of Na in glass and K in the molten salt, by adjusting Na concentration in molten potassium nitrate salt used for the ion exchange, strengthening time, and molten salt temperature. In order to obtain a higher CS, for example, the Na concentration in the molten potassium nitrate salt is decreased.

In a case of performing the ion exchange of Li in glass and Na or K in the molten salt, it is possible by adjusting Li concentration in molten potassium nitrate salt used for the ion exchange, strengthening time, and molten salt temperature. In order to obtain a higher CS, for example, the Li concentration in the molten potassium nitrate salt is decreased.

Adjustment of DOL can be performed by adjusting the concentration of Li and Na in molten potassium nitrate salt used for the ion exchange, strengthening time, and molten salt temperature. In order to obtain a higher DOL, the temperature of the molten salt is increased.

The glass sheet after chemical strengthening can be cut after the chemical strengthening treatment. As a cutting method, it is possible to apply scribing and breaking by a normal wheel tip cutter or diamond cutter, and it is also possible to cut by laser. In order to maintain glass strength, chamfering of the cutting edge may be performed after cutting. The chamfering may be a mechanical grinding process or a treatment method with a chemical solution such as hydrofluoric acid.

In order to maintain strength of the end surface of the glass sheet after the chemical strengthening treatment, the depth of the scratches on the end surface formed during cutting is preferably equal to or less than 5 μm, is more preferably equal to or less than 4 μm, is still more preferably equal to or less than 3 μm, is particularly preferably equal to or less than 2 μm, and is most preferably equal to or less than 1 μm. From the same reason, the curvature radius of the tip end of the scratches on the end surface formed during cutting is preferably equal to or greater than 0.1 μm, is more preferably equal to or greater than 0.5 μm, and is still more preferably equal to or greater than 1 μm.

The glass sheet of the present invention is suitable for a cover glass of a foldable portable terminal, but its application is not limited.

### Examples

Hereinafter, the present invention will be specifically described with reference to Examples, but the present invention is not limited thereto.

### (Manufacturing of Glass Sheet)

A commonly used glass raw material was selected so as to have the composition (mol %) indicated in Table 1 below, and a glass sheet was prepared by a float method. In addition, the obtained glass sheet (thickness: 0.4 mmt to 0.2 mmt) was cut into a size of 300 mm×100 mm, followed by being subjected to slimming by using HF up to the sheet thickness indicated in Table 1 so as to obtain a rectangular glass sheet. The sheet thickness of the glass sheet was measured with a digital micrometer. In addition, the composition of the obtained glass sheet was identified by a fluorescent X-ray method, and it was confirmed to be a desired composition.

Next, chemical strengthening treatment was performed by immersing the glass sheet in a molten potassium nitrate salt having a Na concentration of equal to or less than 0.1% at a temperature of 400° C. for 1.5 hours. Thereafter, it was naturally cooled to room temperature, washed, and dried. CS and DOL of the chemically strengthened glass sheet thus obtained were measured with a surface stress meter (manufactured by Orihara Manufacturing Co., LTD., FSM-6000). Also, CS×DOL/t was calculated from CS (MPa), DOL (μm) and sheet thickness t (mm), and indicated in Table 1.

### (Evaluation of Glass Sheet)

### <Bending Test: Curvature Radius and Fracture Stress>

In order to prevent the surface of the glass sheet from being scratched by the bending test apparatus, the manufactured glass sheet was attached with a scattering prevention film (safety film) having a thickness of 65 μm to one side thereof and was used as a test piece. The evaluation was performed by using a two-surface bending test apparatus as illustrated in FIGS. 3 to 4. At the set position illustrated in FIG. 3, the short side of the test piece 2 was fixed to the upper and lower support boards 14 and 16 with the adhesive tape 17 so that the side on which the scattering prevention film was attached to be in contact with the apparatus, and then the apparatus was set to a test position illustrated in FIG. 4 so that the width D of the glass sheet illustrated in FIG. 1 was 100 mm. Next, the lifting frame 21 was adjusted so that the width D was 50 mm, and the lower side support board 16 was slid by 200 mm or more in the long side direction to perform stress loading on substantially the entire area of the glass sheet. If the glass sheet was not broken, an operation of narrowing the width D by 1 mm and performing the stress loading was repeated similarly until the glass sheet breaks. The radius of curvature (half of the width D) was calculated from the width D between the two faces at the time of breaking. Further, from the width D and the Young's modulus E of the glass sheet, the fracture stress was determined by using the above-mentioned Expression (1).

Since the Young's modulus of the scattering prevention film is less than 1 GPa while the Young's modulus of the glass sheet is about 73 GPa, the influence of the scattering prevention film can be ignored in a case of obtaining the fracture stress.

### <Bending Test: Holding Test for 60 Minutes>

Using the same test piece, it was confirmed that the test piece was not broken after holding for 60 minutes with a width of 1 mm wider than the width at which breakage occurred in the fracture stress test.

### <Bending Test: Repeated Bending>

Regarding the test piece of Example 2, an operation of narrowing the width D from the position of 100 mm to the width of 8 mm by using adjusting unit 30 was repeated 30,000 times, but breakage did not occur. It can be said that the glass sheet of Example 2 has high repetitive strength.

### <Glass Transition Point Tg>

Measurement was performed by using TMA according to the method prescribed in JIS R3103-3 (2001).

### <T₄>

The viscosity was measured by using a rotational viscometer, and the temperature T₄ (° C.) when it was 10⁴ d·Pa·s was measured.

### <T₂>

The viscosity was measured by using a rotational viscometer, and the temperature T₂ (° C.) when it was 10² d·Pa·s was measured.

TABLE 1

| | | | | | | Comp. |
|---|---|---|---|---|---|---|
| | | Ex. 1 | Ex. 2 | Ex. 3 | Ex. 4 | Ex. 1 |
| Composition | SiO₂ | 64.3 | 64.3 | 64.3 | 68 | 68.8 |
| | Al₂O₃ | 10.45 | 10.45 | 10.4 | 10 | 3 |
| | Na₂O | 16 | 16 | 16 | 14 | 14.2 |
| | K₂O | 0.8 | 0.8 | 0 | 0 | 0 |
| | MgO | 8.3 | 8.3 | 0 | 8 | 6.2 |
| | CaO | 0 | 0 | 0 | 0 | 7.8 |
| | ZrO₂ | 0.2 | 0.2 | 0.2 | 0 | 0 |
| | TiO₂ | 0.04 | 0.04 | 0.04 | 0 | 0 |

| | | | | | |
|---|---|---|---|---|---|
| Glass transition | 634 | 634 | 634 | 662 | 549 |
| point (° C.) | | | | | |
| T2(° C.) | 1642 | 1642 | 1642 | 1716 | 1473 |
| T4(° C.) | 1216 | 1216 | 1216 | 1263 | 1042 |
| Sheet thickness (μm) | 100 | 70 | 50 | 50 | 150 |
| CS (MPa) | 750 | 940 | 1100 | 900 | 550 |
| DOL (μm) | 18 | 18 | 18 | 12 | 10 |
| Fracture stress | 645 | 1100 | 1100 | 800 | 522 |
| (average value) | | | | | |
| (MPa) | | | | | |
| Curvature radius (mm) | 7.0 | 3.0 | 2.0 | 3.0 | 13.0 |
| CS × DOL/t | 135 | 242 | 396 | 216 | 37 |

As apparent from Table 1, the glass sheet of Examples 1 to 4 was not broken even when a curvature radius of a bent portion was equal to or smaller than 10 mm in a case where a bending test was performed by a method in which while bending and supporting the glass sheet by a first support board and a second support board which are parallel to each other, the second support board is moved relative to the first support board by equal to or greater than 200 mm in a state of maintaining an interval between a support surface of the first support board and a support surface of the second support board as illustrated in FIG. 3 and FIG. 4. Further, breakage did not occur even after holding for 60 minutes with the curvature radius set to be equal to or less than 10 mm.

Although several embodiments of the present invention have been described above, these embodiments are presented as examples and are not intended to limit the scope of the invention. These novel embodiments can be implemented in various other forms and various omissions, substitutions, and changes can be made without departing from the spirit of the invention. This application is based upon Japanese Patent Application (No. 2017-092675), filed on May 8, 2017, the contents of which are incorporated herein by reference.

### REFERENCE SIGNS LIST

1 GLASS SHEET
2 TEST PIECE
10 BENDING TEST APPARATUS
12 BASE
14 UPPER SIDE SUPPORT BOARD (FIRST SUPPORT BOARD)
14a SUPPORT SURFACE
16 LOWER SIDE SUPPORT BOARD (SECOND SUPPORT BOARD)
16a SUPPORT SURFACE
17 ADHESIVE TAPE
20 MOVING UNIT
21 LIFTING FRAME
22 MOTOR
23 (23a, 23b) BALL SCREW MECHANISM
24 SLIDER BLOCK
30 ADJUSTING UNIT
50 SUPPORTING UNIT
52 HINGE (CONNECTING PORTION)
60 PLACEMENT PORTION

1. A foldable glass sheet having a thickness t of equal to or smaller than 0.2 mm and
having a surface compressive stress CS of greater than 700 MPa,
wherein when the glass sheet is subjected to a bending test in which, while bending and supporting the glass sheet by a first support board and a second support board which are parallel to each other, the second support board is moved relative to the first support board by equal to or greater than 200 mm in a state of maintaining an interval between a support surface of the first support board and a support surface of the second support board, the glass sheet is not broken even in a case where a curvature radius of a bent portion of the glass sheet is set to equal to or smaller than 10 mm.

2. The foldable glass sheet according to claim 1, wherein in the bending test, the glass sheet is not broken in a case where the glass sheet is held in the state for 60 minutes, in which the curvature radius of the bent portion of the glass sheet is equal to or smaller than 10 mm.

3. The foldable glass sheet according to claim 1, which is a chemically strengthened glass, wherein
the surface compressive stress CS is greater than 900 MPa, and
a value (CS×DOL/t) obtained by dividing a product of the surface compressive stress CS (unit: MPa) and a depth of compressive stress layer DOL (unit: μm) by the thickness t (unit: μm) is 116 or more and 450 or less.

4. The foldable glass sheet according to claim 1, which has a matrix composition, by mol % based on oxide, comprising:
SiO₂: 50 to 75%;
Al₂O₃: 8 to 30%;
Na₂O+Li₂O: 10 to 30%;
K₂O: 0 to 2%;
MgO: 3 to 15%;
B₂O₃: 0 to 5%; and
TiO₂+ZrO₂: 0 to 10%.

5. The foldable glass sheet according to claim 1, which has a matrix composition, by mol % based on oxide, comprising:
SiO₂: 50 to 75%;
Al₂O₃: 9 to 20%;
Na₂O: 10 to 20%;
K₂O: 0 to 6%;
MgO: 0 to 15%;
CaO+SrO+BaO: 0 to 10%;
TiO₂+ZrO₂: 0 to 5%;
B₂O₃:0 to 10%; and
Li₂O: 0 to 20%.
